(19) United States
(12) Patent Application Publication
(10) Pub. No.: US 2010/0253198 A1
(43) Pub. Date: Oct. 7, 2010

(54) IMAGE DISPLAY APPARATUS AND MANUFACTURING METHOD OF THE IMAGE DISPLAY APPARATUS

(75) Inventors: Hisafumi Ebisawa, Tokyo (JP); Jun Iba, Yokohama-shi (JP); Ginjirou Toyoguchi, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/730,847

(22) Filed: Mar. 24, 2010

(30) Foreign Application Priority Data
Apr. 6, 2009 (JP) 2009-091855

(51) Int. Cl. H01J 1/02; H01J 9/00

(52) U.S. Cl. 313/1; 445/24

(57) ABSTRACT

An image display apparatus according to the present invention comprises a rear plate having a plurality of electron emitting devices; a face plate having a substrate, a plurality of light emitting members arranged on the substrate, a partition member interposed between the adjacent light emitting members, an anode electrode covering the plurality of light emitting members, and a low potential electrode separated from the anode electrode with an interval and disposed in such a manner as to surround the anode electrode; and a covering member covering an end of the low potential electrode on a side of the anode electrode in separation from the anode electrode, wherein a potential to be applied to the low potential electrode is lower than that to be applied to the anode electrode, and the covering member and the partition member are made of the same material.

### BACKGROUND OF THE INVENTION

1. Field of the Invention

The present invention relates to an image display apparatus and a manufacturing method of the image display apparatus.

2. Description of the Related Art

An image display apparatus having a plurality of electron emitting devices has been developed in recent years. Such an image display apparatus includes a rear plate, a face plate, and a frame for fixing the face plate and the rear plate in a facing state. The rear plate includes a plurality of electron emitting devices. The face plate includes a plurality of light emitting members disposed opposite to the plurality of electron emitting devices, respectively, an anode electrode covering the plurality of light emitting members, and the like. When a high-voltage is applied between the face plate and the rear plate (specifically, between the electron emitting device and the anode electrode), an electron emitted from the electron emitting device can be accelerated to collide against the light emitting member. In this manner, the light emitting member emits light, thereby displaying an image.

In the above image display apparatus, an interval between the face plate and the rear plate is kept from 1 mm to 10 mm to obtain a high brightness and high definition image. Since the high voltage is applied to such a narrow interval, there has arisen a problem of electric discharge occurring at a position at which an electric field is liable to be concentrated, for example, at a bonded portion between the face plate and the frame. Specifically, there has arisen a problem of electric discharge occurring between the anode electrode and an unexpected portion (e.g., a projecting portion) of an adhesive for use in bonding. Such occurrence of electric discharge induces a fear of misalignment of an image to be displayed or breakage of the electron emitting device or a drive circuit for the electron emitting device.

As the conventional art for suppressing such electric discharge, there is an image display apparatus including a low potential electrode separated from an anode electrode with an interval and disposed around the anode electrode. This image display apparatus can reduce an electric field generated outside (i.e., on a side of a frame) of the low potential electrode by setting a potential to be applied to the low potential electrode lower than that to be applied to the anode electrode. In other words, there is an image display apparatus including the low potential electrode functioning as a potential shield.

The provision of the above low potential electrode can suppress the occurrence of the electric discharge between the anode electrode and a bonded portion. However, a strong electric field is formed between the anode electrode and the low potential electrode (at as small an interval as several mm), thereby raising a problem of occurrence of electric discharge between the anode electrode and the low potential electrode.

The conventional art has been accomplished in view of the above problems, as disclosed in Japanese Patent Application Laid-open No. 2006-059638. Specifically, Japanese Patent Application Laid-open No. 2006-059638 discloses an image display apparatus including a highly resistance member covering an end of a low potential electrode on a side of an anode electrode. With this configuration, should an electron be emitted from the low potential electrode, the electron is moved through the highly resistance member, thus suppressing occurrence of electric discharge.

### SUMMARY OF THE INVENTION

However, the image display apparatus disclosed in Japanese Patent Application Laid-open No. 2006-059638 need be independently provided with the above highly resistance member, thereby requiring a cumbersome manufacturing process and inducing a problem of an increased cost.

An object of the present invention is to provide an image display apparatus capable of suppressing occurrence of electric discharge with a simple configuration and a manufacturing method therefor.

An image display apparatus according to the present invention comprising:

a rear plate having a plurality of electron emitting devices;

a face plate having a substrate, a plurality of light emitting members arranged on the substrate in such a manner as to face the plurality of electron emitting devices, respectively, a partition member interposed between the adjacent light emitting members and projecting toward the rear plate beyond the light emitting member, an anode electrode covering the plurality of light emitting members, and a low potential electrode separated from the anode electrode with an interval and disposed in such a manner as to surround the anode electrode; and

a covering member covering an end of the low potential electrode on a side of the anode electrode in separation from the anode electrode,

wherein a potential to be applied to the low potential electrode is lower than that to be applied to the anode electrode, and

the covering member and the partition member are made of the same material.

A manufacturing method of an image display apparatus according to the present invention comprising:

forming a rear plate having a plurality of electron emitting devices; and

forming a face plate having a substrate, a plurality of light emitting members arranged on the substrate in such a manner as to face the plurality of electron emitting devices, respectively, a partition member interposed between the adjacent light emitting members and projecting toward the rear plate beyond the light emitting member, an anode electrode covering the plurality of light emitting members, a low potential electrode separated from the anode electrode with an interval and disposed in such a manner as to surround the anode electrode, and a covering member for covering an end of the low potential electrode on a side of the anode electrode in separation from the anode electrode;

wherein the covering member and the partition member are formed of the same material and by the same process.

According to the present invention, it is possible to provide the image display apparatus capable of suppressing the occurrence of the electric discharge with the simple configuration and the manufacturing method therefor.

Further features of the present invention will become apparent from the following description of exemplary embodiments with reference to the attached drawings.

### BRIEF DESCRIPTION OF THE DRAWINGS

FIGS. 1A to 1C are views showing the configuration of a face plate according to an embodiment of the present invention.

FIGS. 2A to 2C are views showing the shapes of a covering member according to the embodiment.

FIG. 3 is a view showing the configuration of a face plate in Examples 1 to 3.

FIG. 4 is a view showing the basic configuration of an image display apparatus according to the embodiment.

FIGS. 5A and 5B are views showing the shape of a covering member in Example 1.

FIGS. 6A and 6B are views showing the shape of a covering member in Example 2.

FIGS. 7A and 7B are views showing the shape of a covering member in Example 3.

### DESCRIPTION OF THE EMBODIMENTS

An image display apparatus and a manufacturing method therefor according to the present embodiment will be below. The image display apparatus according to the present embodiment includes a plurality of electron emitting devices. For example, the electron emitting device is a surface-conduction electron-emitting device, a spindt type electron emitting device, an MIM type electron emitting device, an electron emitting device using a carbon nanotube, a ballistic electron surface-emitting device, and the like.

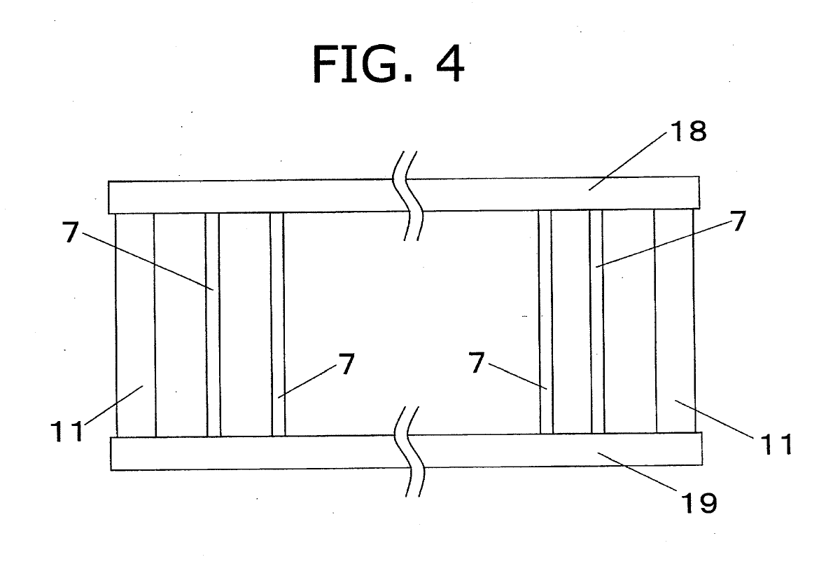

The basic configuration of the image display apparatus according to the present embodiment will be described below with reference to FIG. 4. FIG. 4 is a cross-sectional view showing the image display apparatus according to the present embodiment. In the present embodiment, the cross sectional view show a cross section that is obtained by a plane perpendicular to a display surface (i.e., a surface on which an image is displayed).

The image display apparatus according to the present embodiment includes a rear plate 18 having a plurality of electron emitting devices and a face plate 19 facing the rear plate 18. The peripheral edge of the rear plate 18 and the peripheral edge of the face plate 19 are fixed on a frame 11. The rear plate 18, the faceplate 19, and the frame 11 form an envelope. The rear plate 18 includes electrodes for driving the electron emitting devices and wirings in addition to the electron emitting devices. In order to keep the inside of the envelope in vacuum, (plate-like or columnar) spacers 7 serving as atmosphere resistant structures (i.e., ribs) are interposed between the rear plate 18 and the face plate 19.

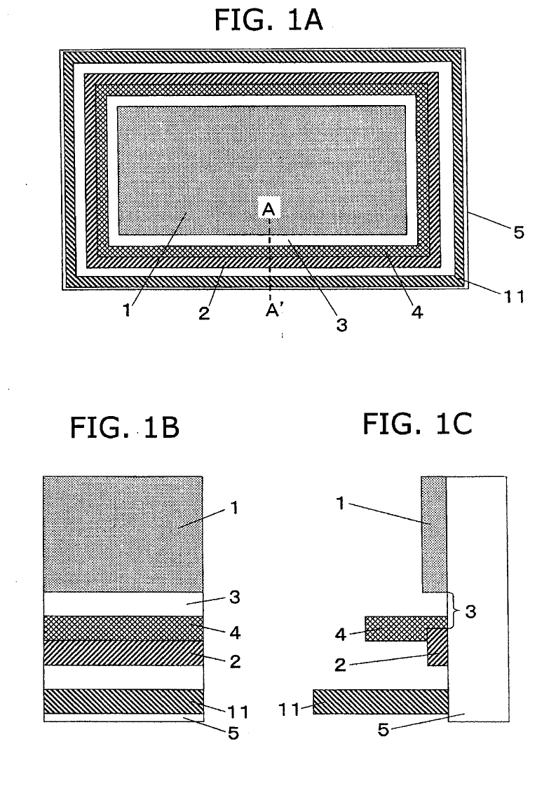

The configuration of the face plate 19 will be described below with reference to FIGS. 1A to 1C. FIG. 1A is a top view showing the face plate (as viewed from the rear plate); and FIGS. 1B and 1C are a top view and a cross-sectional view, respectively, showing detail of the vicinity of a broken line A-A′ in FIG. 1A.

The faceplate 19 includes a substrate 5, a plurality of light emitting members (such as phosphors), not shown, partition members, not shown, an anode electrode 1, a low potential electrode 2, a covering member 4. The plurality of light emitting members are arranged on the substrate in such a manner as to face the plurality of electron emitting devices, respectively.

The partition member is interposed between the adjacent light emitting members and projects toward the rear plate beyond the light emitting members, thereby reducing halation (a halation phenomenon). The halation signifies unintended light emission caused by reflection (elastic scattering) of an electron on the light emitting member which is inherently irradiated with the electron and accidental irradiation of the reflected electron to an adjacent light emitting member. Such light emission leads to a blur of an image. Therefore, the partition member generally has a sufficient height.

The anode electrode 1 covers the plurality of light emitting members. The low potential electrode 2 (a GND; a guard ring electrode) is disposed with an interval (a gap 3) from the anode electrode 1 and surrounds the anode electrode 1. The covering member 4 (an insulating film; a high voltage withstanding structure) is separated from the anode electrode 1 and covers an end of the low potential electrode 2 on the side of the anode electrode. The width of the gap 3 can be preferably set to not less than 0.5 mm and not more than 10 mm, more preferably, not less than 1 mm and not more than 5 mm.

In the above image display apparatus, a high voltage is applied between the anode electrode 1 and the electron emitting device (that is, a high potential is applied to the anode electrode 1), thereby accelerating an electron emitted from the electron emitting device, to allow the electron to collide against the light emitting member. Consequently, the light emitting member emits light, thus displaying an image.

Moreover, in the image display apparatus according to the present embodiment, by providing the low potential electrode 2 and the covering member 4, occurrence of electric discharge is suppressed, like in the image display apparatus disclosed in Japanese Patent Application Laid-open No. 2006-059638. In other words, by providing the low potential electrode 2, the occurrence of the electric discharge between the fixed portion between the face plate 19 and the frame 11 and the anode electrode 1 is suppressed. In addition, by providing the covering member 4, the occurrence of the electric discharge between the anode electrode 1 and the low potential electrode 2 is suppressed. Here, a lower potential is applied to the low potential electrode 2 than a potential to be applied to the anode electrode 1 (in general, a GND potential). Specifically, a potential difference (a gap) between the anode electrode 1 and the low potential electrode 2 can be preferably 10 kV/mm or less.

In the present embodiment, the covering member 4 and the partition member are made of the same material. The material of the covering member 4 and the partition member include borosilicate glass and bismuth-based frit glass. The partition member can be desirably about 50 μm to 400 in height and about 50 μm to 2000 μm in width, although it is not limited to these. Since the covering member 4 and the partition member are made of the same material, both of the members can be formed in one and the same process.

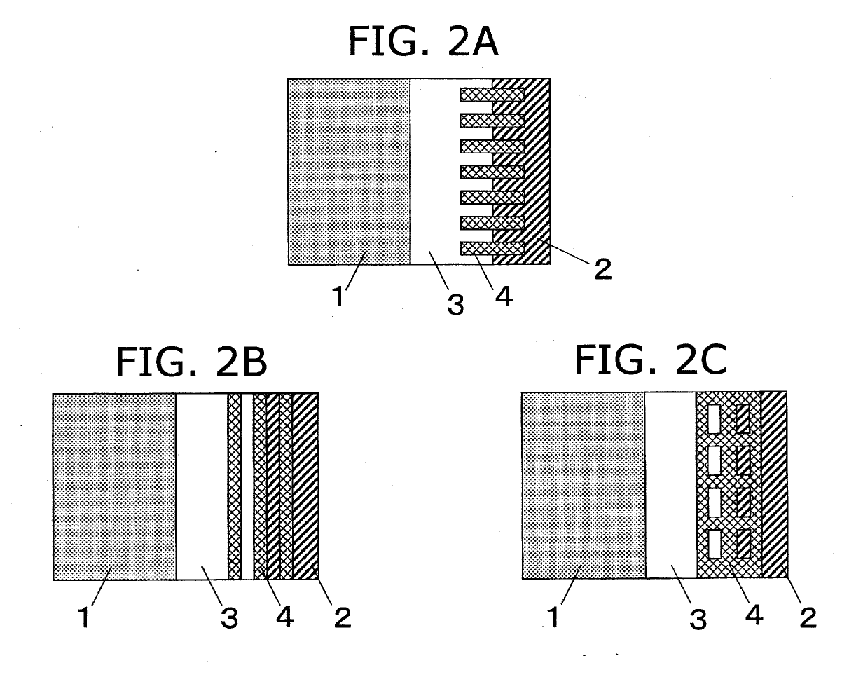

Next, the shapes of the covering member 4 will be described with reference to FIGS. 2A to 2C which are top views showing a part of the face plate.

In the shape shown in FIG. 2A, there are portions where no covering member 4 may be disposed between the low potential electrode 2 and the anode electrode 1. Electric discharge is liable to occur at such portions, and therefore, the shape shown in FIG. 2A is unpreferable. In other words, it is desirable that the covering member should exist between the low potential electrode 2 and the anode electrode 1.

In contrast, the shapes shown in FIGS. 2B and 2C are more preferable than the shape shown in FIG. 2A since the end of the low potential electrode 2 on the side of the anode electrode 1 is completely covered. Moreover, the shapes shown in FIGS. 2B and 2C have a groove or a recess in the covering member 4. Specifically, in the shape shown in FIG. 2B (having a groove), the low potential electrode 2 is made to a plurality of annular members; in contrast, in the shape shown in FIG. 2C (having a recess), the low potential electrode 2 has a plurality of openings.

With these configurations, stress concentration can be alleviated, and further, mechanical strength can be enhanced (without the groove or the recess, breakage or peeling-off may be possibly caused by a stress generated in forming (baking) the covering member 4). In particular, the shape shown in FIG. 2C is preferable because it is higher in mechanical strength and voltage withstanding and harder to be peeled off than the shape shown in FIG. 2B. Here, it is desirable that the end of the low potential electrode should not be exposed due to the openings. Incidentally, the covering member 4 may not be provided with the groove or the recess as long as it can suppress the occurrence of the electric discharge and has sufficient mechanical strength.

In the shapes shown in FIGS. 2B and 2C, the width of the groove or the recess can be preferably 15% to 85% of the entire width of the covering member 4 (equivalent to a distance from an end on the side of the low potential electrode 2 to an end on the side of the anode electrode 1). Moreover, the widthwise distance between the openings can be preferably greater than about 50 μm. In other words, when the low potential electrode 2 or the gap 3 (i.e., the substrate 5) is exposed via the groove or the recess, the covering member 4 can be preferably formed in such a manner as to satisfy these conditions. Consequently, it is possible to form the covering member 4 excellent in mechanical strength and voltage withstanding. Here, a distance between the openings in a direction other than the widthwise direction does not particularly have a favorable value from the electric viewpoint, and therefore, it may be any value as long as mechanical strength enough to prevent any breakage may be achieved.

### EXAMPLES

Hereinafter, descriptions of specific examples (Examples 1 to 3) of the image display apparatus according to the present embodiment will be given. Here, the present invention is not limited to Examples 1 to 3, but the method of formation, size, material, shape, and the like of each of the members are determined, as required.

### Example 1

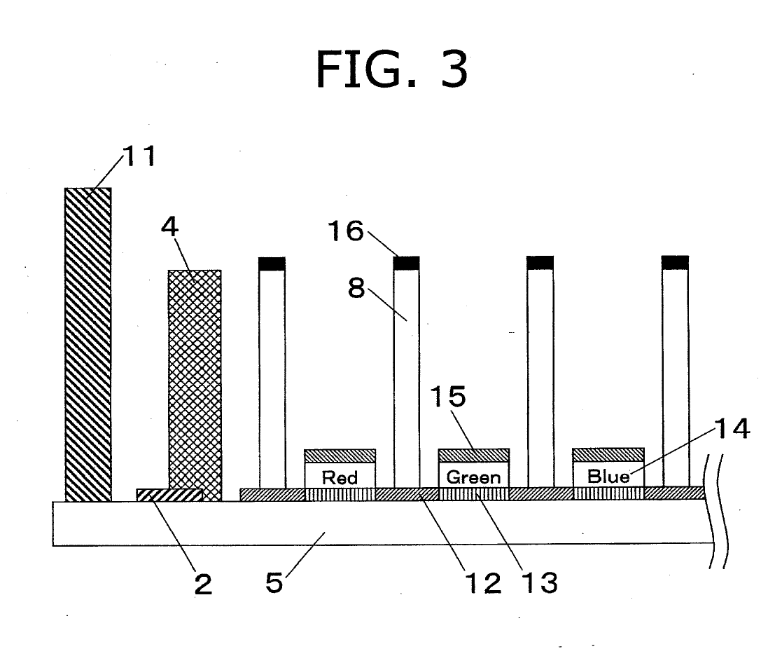

Hereinafter, description will be given a manufacturing method of the image display apparatus in Example 1 with reference to FIG. 3 (exemplifying a cross section of a face plate which passes through a light emitting member and a partition member and is obtained on a plane vertical to a display surface). Here, a rear plate having a plurality of electron emitting devices may be formed by various methods proposed in the conventional art, and therefore, its description will not be repeated below whereas the formation of the faceplate will be described in detail. Incidentally, a plurality of electron emitting devices is arranged on a rear plate in a matrix manner in Example 1.

First, a glass substrate having a thickness of 1.8 mm (PD200: manufactured by ASAHI GLASS CO., LTD.) was prepared as a substrate 5. Thereafter, one surface of the substrate 5 (i.e., a surface facing a rear plate, or a substrate surface) was coated with a conductive material (i.e., a coating material) serving as both of a low potential electrode 2 and a black matrix 12 by printing method. Here, the conductive material (or a material obtained by mixing an insulating material with a conductive material) may be used as the coating material, and therefore, the material may be utilized as the low potential electrode 2. Specifically, cobalt oxide Co₃O₄ as a conductive black pigment was used as the coating material. Incidentally, the low potential electrode 2 and the black matrix 12 may be formed of different materials. In such a case, the black matrix 12 may be made of an insulting material.

Next, the coating material at portions where light emitting members were to be formed was removed in a photo process. Consequently, a plurality of openings was formed (each of the openings corresponds to one pixel). In this example, the plurality of electron emitting devices was arranged in the matrix manner, and accordingly, the plurality of openings also were arranged in the matrix manner (the plurality of openings were formed in such a manner that the positions of the plurality of openings corresponded to those of the plurality of electron emitting devices, respectively).

At that time, the coating material at a portion corresponding to an interval between an anode electrode 1 and the low potential electrode 2 (i.e., a gap 3) also was removed. Consequently, the anode electrode 1 (which was formed later) was electrically independent of (conductively disconnected from) the low potential electrode 2. Then, the coating material was baked at a temperature of 170° C. In the above process, the black matrix 12 and the low potential electrode 2 were formed. Here, the width of the gap 3 was set to about 4 mm in Example 1.

Subsequently, partition members 8 were formed between the light emitting members (specifically, between the openings in the black matrix 12 formed in the above manner). Specifically, a paste material was uniformly applied onto the black matrix 12 by a slit coater. Thereafter, the paste material was patterned in a stripe shape in parallel in one direction (vertically or laterally) on a display surface between the openings and at intervals of one pixel in a photo process. The paste material was baked at 580° C., thereby forming the partition members 8. In this example, the partition member 8 was formed of a bismuth oxide-based insulating paste. The height of the partition member 8 after being baked was 200 μm.

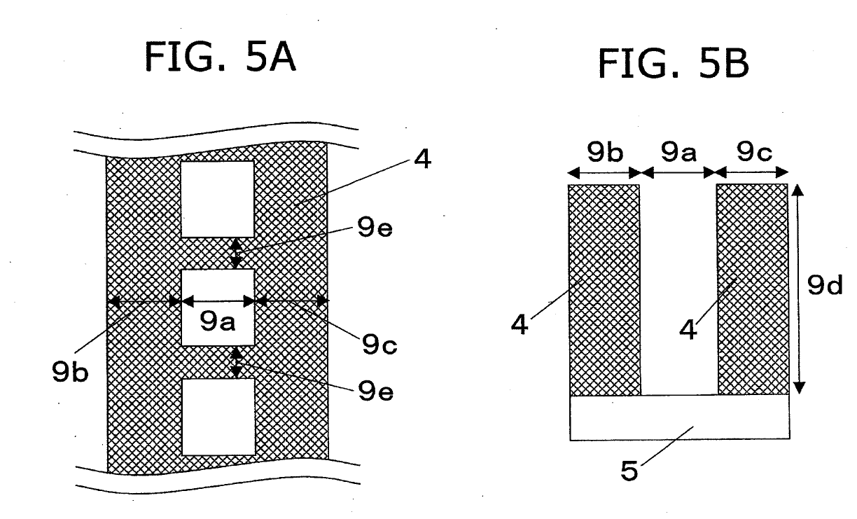

In forming the partition member 8 (that is, in the same process as that for forming the partition member 8), a covering member 4 was made of the same material of that of the partition member 8. In this example, the covering member 4 was formed into such a shape as to have a plurality of openings arranged in a longitudinal direction (in a direction along the end of the low potential electrode 2), as shown in FIGS. 5A and 5B (i.e., a grid shape or a waffle shape). Here, FIGS. 5A and 5B are a top view and a cross-sectional view, respectively, showing a part of the covering member 4. The height 9d of the covering member 4 was equal to that of the partition member 8, that is, 200 μm. The width 9a of the opening was set to 500 μm; the width 9b of the covering member 4 on one side in a opening portion, to 500 μm; and the width 9c of the covering member 4 on the other side of the opening portion, to 500 μm (as a consequence, the entire width of the covering member 4 was 1500 μm). An interval 9e between the adjacent openings in the longitudinal direction in FIG. 5A was set to 50 μm.

Next, color filters 13 of red, green, and blue were formed in the openings (one color to one opening) in the black matrix 12 (i.e., between the adjacent partition members 8). Specifically, Fe₂O₃ was used as a material for the red color filter; Co(AlCr)₂O₄ and (CoNiZn)₂TiO₄, as a material for the green color filter; and Al₂O₃.CoO, as a material for the blue color filter. Those materials were coated by a dispenser. The coated materials were baked at a temperature of 500° C., thereby obtaining the color filters 13. In this example, the color filters 13 were formed in such a manner that the filters of the same color are arranged in the same row and three rows constitute the three colors. Incidentally, the arrangement of the color filters 13 is not limited to this, but may be appropriately varied.

Subsequently, light emitting members 14 for red, green, and blue colors (one color for one opening) were formed on the color filters 13 (light emitting members 14 of the corresponding colors (i.e., the same colors) were formed on the color filters 13, respectively). Specifically, the light emitting member 14 for the red color was made of Y₂O₂S:Eu; the light emitting member 14 for the green color, SrGa₂S₄:Eu; and the light emitting member 14 for the blue color, ZnS:Ag, Al. Those materials were coated by a dispenser, and then, the coated materials were dried, followed by baking at a temperature of 500° C., thereby obtaining the light emitting members 14.

Here, the thickness of the color filter 13 of each of the red, green, and blue colors was set to about 0.5 to 3 μm. In contrast, the thickness of the light emitting member 14 of each of the red, green, and blue colors was set to about 7 to 15 μm.

The substrate surface was uniformly spray-coated a solution containing alkaline silicate, that is, so-called water glass, followed by drying at a temperature of 170° C. Thus, the light emitting members 14 were bonded onto the substrate 5.

After bonding the light emitting members 14, the surfaces of the light emitting members 14 were coated with paste including an ethyl cellulose resin and butyl carbitol acetate in mixture, followed by drying at a temperature of 170° C. In that manner, clearances among particles in the light emitting member 14 were embedded with the paste, and therefore, the surface of the light emitting member 14 became flattened.

Thereafter, a resistance member 16 was formed on the partition member 8. Specifically, the resistance member 16 was made of a mixture of ATO coated TiO₂ and bismuth-based frit glass. The material was coated by printing method, followed by patterning in a photo process. The material remaining on the partition member 8 after the patterning was baked at a temperature of 170° C., thus obtaining the resistance member 16.

Next, a metallic film (i.e., a metal back 15) for accelerating the electron emitted from the electron emitting device (i.e., for enhancing the electron taking-out efficiency from the light emitting member 14) was formed on the light emitting member 14 (i.e., between the adjacent partition members 8). By electrically connecting between the resistance member 16 and the metal back 15, an anode electrode 1 including the resistance member 16 and the metal back 15 was formed. Specifically, a dry film resist (abbreviated as a DFR) was stuck over the entire substrate by a laminator apparatus. An exposing chromium mask was aligned at a predetermined position, followed by pattern-exposing the DFR. Thereafter, aluminum was deposited up to a thickness of about 120 nm by a vapor depositor. Then, the metal back 15 was obtained through development and rinsing.

Although the anode electrode 1 included the resistance member 16 and the metal back 15 in this example, the configuration of the metal back 15 is not limited to this. For example, when the metal back 15 is not split (that is, a single sheet), the metal back 15 serves as an anode electrode. In contrast, when the metal back 15 is split into a plurality of pieces, it may be electrically connected to a member other than the resistance member 16.

The face plate in this example was formed through the above processes. The resultant face plate, the rear plate, and the frame constitute an envelope, thus manufacturing the image display apparatus in this example.

In the image display apparatus in this example, a voltage Va of 10 kV was applied between the anode electrode 1 and the electron emitting device. As a result, no electric discharge occurred between the anode electrode 1 and the low potential electrode 2, thus displaying an image (a picture) in the image display apparatus without any trouble.

Moreover, also when the image display apparatus was driven for about one hour after a voltage Va of 12 kV was applied to enhance brightness, no electric discharge occurred. Thus, persistence of the above effect could be revealed.

### Example 2

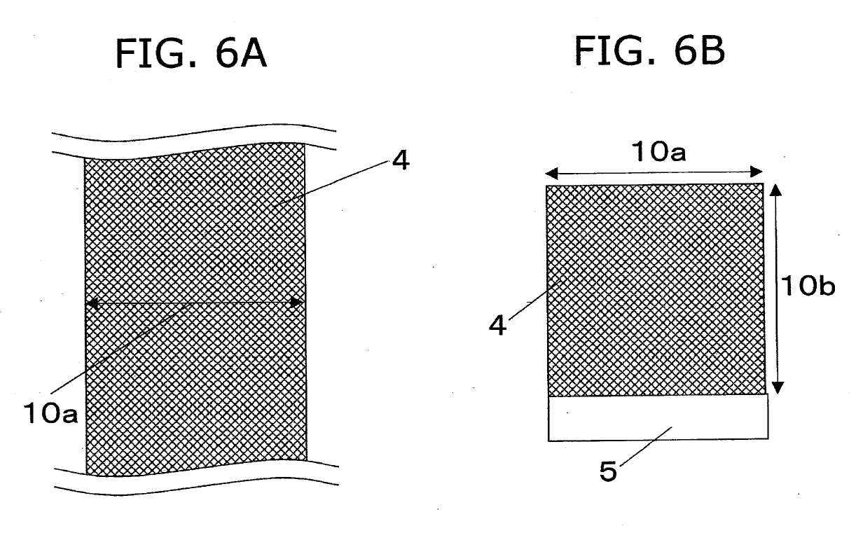

An image display apparatus in Example 2 will be described below. Here, the basic configuration and the manufacturing method are the same as those in Example 1, and therefore, the description will be omitted. In this example, the shape of a covering member 4 is different from that in Example 1. Specifically, the covering member 4 was formed into a belt-like shape without any groove or recess in this example, as shown in FIGS. 6A and 6B. FIGS. 6A and 6B are a top view and a cross-sectional view, respectively, showing a part of the covering member 4. The height 10b of the covering member 4 was set to 200 μm. The entire width 10a of the covering member 4 was set to 1500 μm.

In an image display apparatus manufactured in this example, a voltage Va of 12 kV was applied between an anode electrode 1 and an electron emitting device. As a result, even when the image display apparatus was driven for about one hour, no electric discharge occurred, thus producing the same effect as that produced in Example 1.

### Example 3

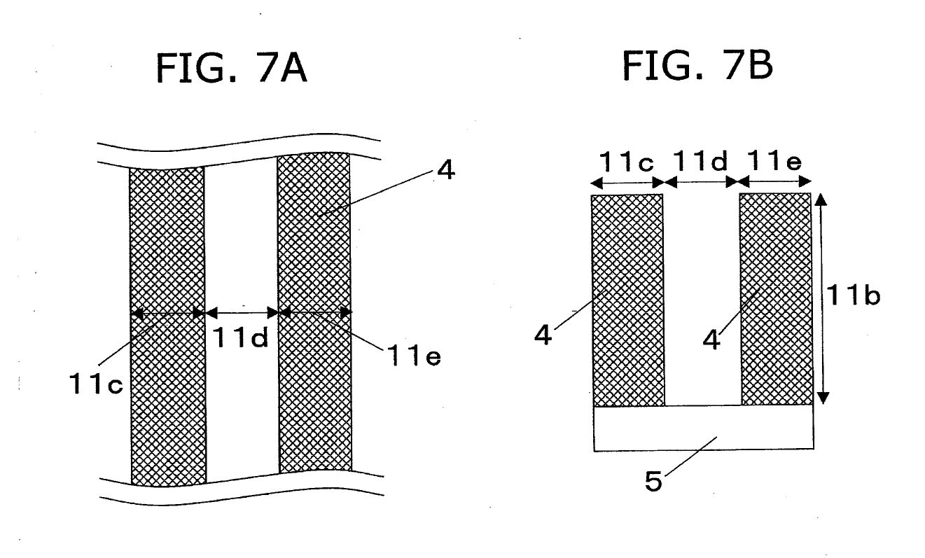

An image display apparatus in Example 3 will be described below. Here, the basic configuration and the manufacturing method are the same as those in Examples 1 and 2, and therefore, the description will not be repeated. In this example, the shape of a covering member 4 is different from those in Examples 1 and 2. Specifically, the covering member 4 included two annular members in this example, as shown in FIGS. 7A and 7B which are a top view and a cross-sectional view showing a part of the covering member 4. The height 11b of the covering member 4 was set to 200 μm. A width 11d between the two annular members was set to 500 μm. The width 11c of one of the annular members was set to 500 μm whereas the width 11e of the other annular member was set to 500 μm (as a consequence, the entire width of the covering member was set to 1500 μm).

In an image display apparatus manufactured in this example, a voltage Va of 12 kV was applied between an anode electrode 1 and an electron emitting device. As a result, even when the image display apparatus was driven for about one hour, no electric discharge occurred, thus producing the same effect as that produced in Example 1.

As described above, the occurrence of the electric discharge can be suppressed with the simple configuration in which the covering member is formed of the same material as that of the partition member in the image display apparatus in the present embodiment. Specifically, the covering member and the partition member can be formed in one and the same process since they are made of the same material. Consequently, the image display apparatus excellent in voltage withstanding can be manufactured at a reduced cost without adding another process. In particular, when the covering member and the partition member are formed in the photo process, the covering member can be formed without any increase in cost.

Since the partition member is adapted to reduce halation, it has the sufficient height. In Examples 1 to 3, the covering member and the partition member are equal to each other in height, so that the volume (in particular, the height) of the covering member can be sufficiently secured, thus enhancing creepage resistance between the anode electrode and the low potential electrode. Moreover, with this configuration, the electron emitted from the low potential electrode can be securely suppressed. Thus, it is possible to enhance the voltage withstanding more than in the conventional art.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-091855, filed on Apr. 6, 2009, which is hereby incorporated by reference herein in its entirety.

What is claimed is:

1. An image display apparatus comprising:
a rear plate having a plurality of electron emitting devices;
a face plate having a substrate, a plurality of light emitting members arranged on the substrate in such a manner as to face the plurality of electron emitting devices, respectively, a partition member interposed between the adjacent light emitting members and projecting toward the rear plate beyond the light emitting member, an anode electrode covering the plurality of light emitting members, and a low potential electrode separated from the anode electrode with an interval and disposed in such a manner as to surround the anode electrode; and
a covering member covering an end of the low potential electrode on a side of the anode electrode in separation from the anode electrode,
wherein a potential to be applied to the low potential electrode is lower than that to be applied to the anode electrode, and
the covering member and the partition member are made of the same material.

2. An image display apparatus according to claim 1, wherein the covering member and the partition member are formed by the same process.

3. An image display apparatus according to claim 1, wherein the covering member and the partition member have the same height.

4. An image display apparatus according to claim 1, wherein the covering member has a groove or a recess.

5. A manufacturing method of an image display apparatus comprising the steps of:
forming a rear plate having a plurality of electron emitting devices; and
forming a face plate having a substrate, a plurality of light emitting members arranged on the substrate in such a manner as to face the plurality of electron emitting devices, respectively, a partition member interposed between the adjacent light emitting members and projecting toward the rear plate beyond the light emitting member, an anode electrode covering the plurality of light emitting members, a low potential electrode separated from the anode electrode with an interval and disposed in such a manner as to surround the anode electrode, and a covering member for covering an end of the low potential electrode on a side of the anode electrode in separation from the anode electrode;
wherein the covering member and the partition member are formed of the same material and by the same process.
